(19) United States
(12) Patent Application Publication
(10) Pub. No.: US 2010/0132979 A1
(43) Pub. Date: Jun. 3, 2010

(54) WIRE KEEPER

(76) Inventor: Deng-Hsi CHEN, Keelung (TW)

Correspondence Address: Muncy, Geissler, Olds & Lowe, PLLC, 4000 Legato Road, Suite 310, FAIRFAX, VA, 22033, US

(21) Appl. No.: 12/506,819

(22) Filed: Jul. 21, 2009

(30) Foreign Application Priority Data
Nov. 28, 2008 (TW) 097221398

(51) Int. Cl. H01B 7/00

(52) U.S. Cl. 174/135

(57) ABSTRACT

A wire keeper is assembled in a computer case to guide, integrate and fix wires of plural bus lines and electric connecting cords which are layout in the case, allowing each wire in the case to be tidily collected to assure space in the case to keep clear properly. As a result, hot air in the case can be transmitted out successfully by a cooling fan to effectively improve a heat dissipation effect in the case.

### BACKGROUND OF THE INVENTION

a) Field of the Invention

The present invention relates to a wire keeper which is assembled in a computer case to tidily and orderly collect all kinds of wires in the case, and more particularly to a wire keeper which is provided with functions of guiding, integrating and fixing the wires.

b) Description of the Prior Art

A computer case is used primarily to carry all kinds of related electronic devices, such as a motherboard, a power supply, an interface card and a hard disk drive; whereas, all kinds of electric connectors complying with specifications are connected among the electronic devices. Therefore, in addition to the electronic devices of all hardware, the case also includes plural kinds of wires of electric connecting cords, in general. As each electronic device is located differently, after the electronic devices are electrically connected among one another, most space in the case has been already occupied by the wires of several kinds of electric connecting cords. As a result, not only that the space in the case will be very disordered, but also that air circulation ability in the case will be decreased indirectly. Therefore, after the computer has begun to operate, heat generated by all the electronic devices in the case will not be able to be dissipated successfully by a cooling fan that a heat dissipation effect will be reduced correspondingly, thereby affecting an operating efficiency of the computer.

### SUMMARY OF THE INVENTION

Accordingly, the primary object of the present invention is to provide a wire keeper which can be assembled in a computer case and is provided with functions of guiding, integrating and fixing wires.

To achieve the aforementioned object, the present invention aims toward research and development for a simple structure and easiness of assembling. A wire keeper of the present invention includes primarily an assembly portion above which is formed with more than one through-hole; whereas, above the through-hole is formed with an elastic insertion slot from which a wire is put into the through-hole. On the other hand, a single through-hole is provided with a guiding effect that the wire can be fixed along a same axial direction, and is also provided with an effect of integrating the wires. Moreover, two neighboring through-holes can allow longer wires to be wound. Accordingly, the present invention can fix the wires, tidily collect all the wires in the case and assure keeping the space for air circulating in the case to improve the heat dissipation effect in the case.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a three-dimensional perspective view of the present invention.

FIG. 2 shows a schematic view of a first preferred embodiment of the present invention.

FIG. 3 shows a schematic view of a second preferred embodiment of the present invention.

FIG. 4 shows a schematic view of a third preferred embodiment of the present invention.

FIG. 5 shows a schematic view of a fourth preferred embodiment of the present invention.

### DETAILED DESCRIPTION OF THE PREFERRED EMBODIMENTS

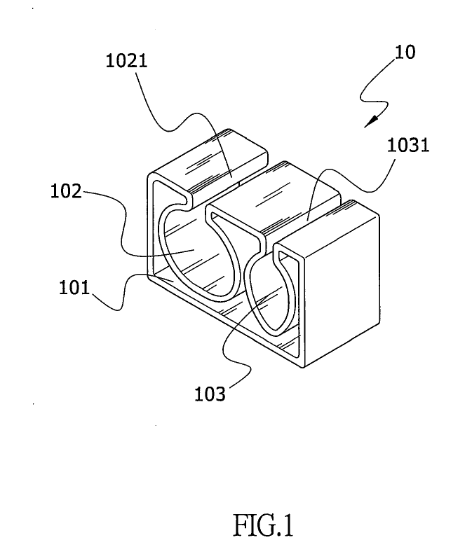

Referring to FIG. 1, it shows a three-dimensional perspective view of the present invention. As shown in the drawing, a wire keeper 10 comprises primarily an assembly portion 101, a bottom of which is in a planar shape that the assembly portion 101 can be assembled flat on a plane inside a computer case. In addition, the assembly portion 101 is extended upward to form with a through-hole 102 and there are more than two through-holes in the present drawing, including the through-holes 102 and 103. When the assembly portion 101 is formed with more than two through-holes 102, 103, aperture sizes of the through-holes can be same or different. Furthermore, upper rims of the through-holes 102, 103 are formed respectively with a notch-like elastic insertion slot 1021, 1031.

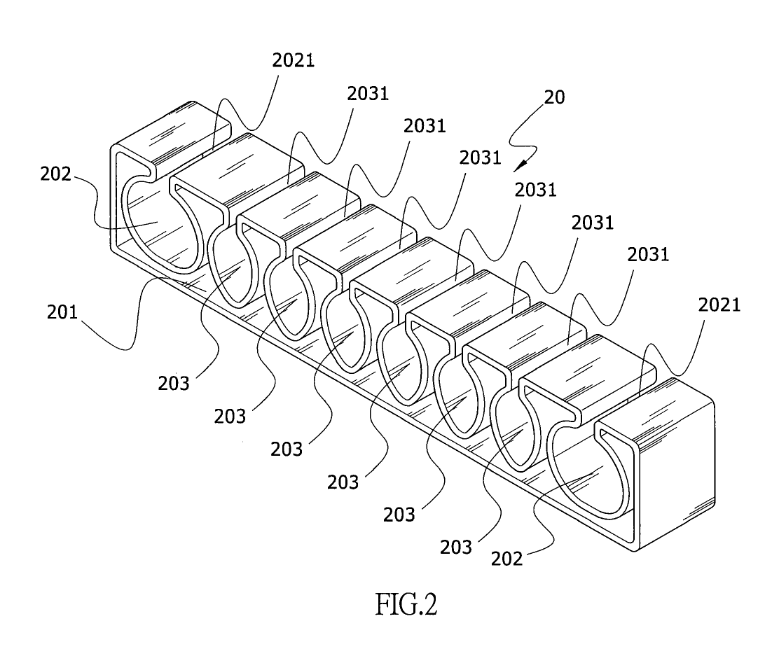

Referring to FIG. 2, it shows a schematic view of a first preferred embodiment of the present invention. As shown in the drawing, a wire keeper 20 is formed with more through-holes 202, 203 than the wire keeper 10 called by the present invention, and more than two aperture sizes can be formed as required by using a mold design while manufacturing to comply more with a practical need. As shown in the drawing, two ends of the assembly portion 201 are formed respectively with a through-hole 202 of a larger aperture; whereas plural through-holes 203 of a smaller aperture are formed between the two through-holes 202. Thus, the through-holes 202 of the larger aperture can provide for transfixing an electric connecting cored of more wires (not shown in the drawing), such as an electric connecting cord of a power supply. On the other hand, the through-holes 203 of the smaller aperture provide for transfixing the connecting cords of fewer wires. Referring to the drawing again, an upper rim of each through-hole 202 is formed respectively with a notch-like elastic insertion slot 2021 and an upper rim of each through-hole 203 is formed respectively with a notch-like elastic insertion slot 2031 as well, allowing the wires to be transfixed into each through-hole 202 or 203 through the insertion slot 2021 or 2031. As the insertion slots 2021, 2031 are provided with a proper gap and are elastic, the wires will not be escaped easily after being put into. Moreover, the wire keeper 20 called by the present invention can be formed integrally by an elastic plastic material. As a result, each through-hole 202, 203 is also elastic and when there are more wires, each wire can be bond in the through-hole 202, 203 by an elastic force.

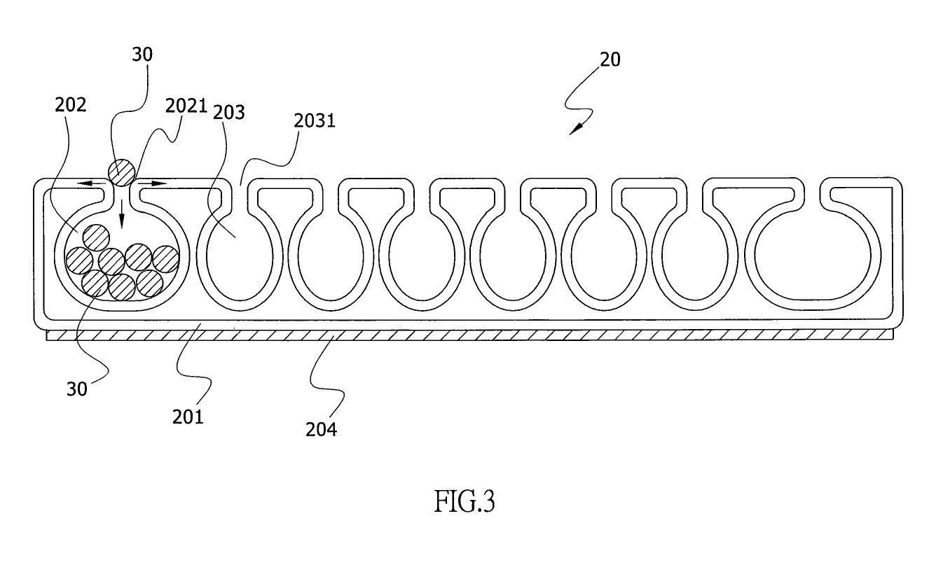

Referring to FIG. 3, it shows a schematic view of a second preferred embodiment of the present invention. As shown in the drawing, when a wire 30 is to be put into the through-hole 202, the wire 30 can be inserted into the through-hole 202 directly by transfixing or from the insertion slot 2021 above the through-hole 202; whereas, when the wire 30 of a larger diameter is inserted or many wires 30 are inserted at a same time, a little force can apply to the insertion slot 2021 that the insertion slot 2021 is opened a little by elasticity. After the wire 30 has been inserted, the insertion slot 2021 can still restore to the original gap by the elasticity. As shown in the drawing again, a bottom of the assembly portion 201 is in a planar shape, allowing the assembly portion 201 to be stably assembled on a plane inside the computer case, and a proper position on the bottom plane of the assembly portion 201 can be attached with a double sided adhesive 204 that the assembly portion 201 can be fixed on the plane inside the computer case at a location corresponding to the double sided adhesive 204 by attaching rapidly, when the entire wire keeper 20 is to be assembled on the plane inside the computer case.

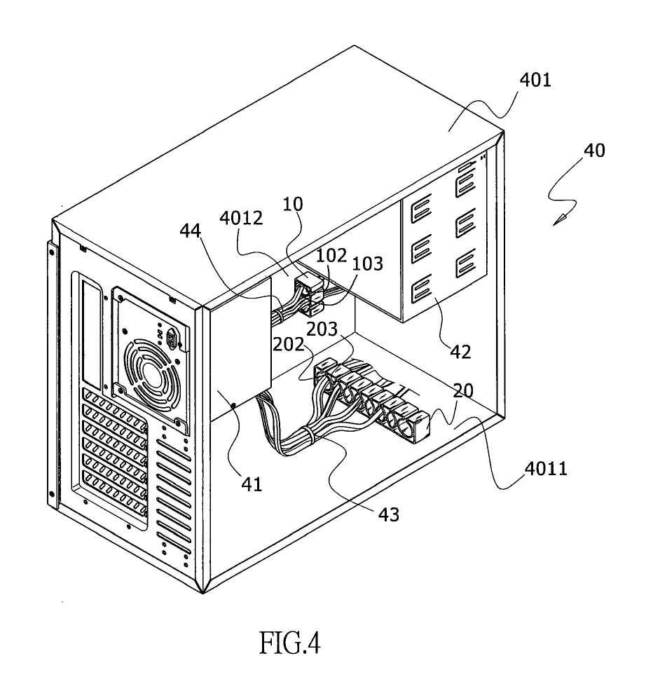

Referring to FIG. 4, it shows a schematic view of a third preferred embodiment of the present invention. As shown in the drawing, for a case 401 of a computer 40, an interior space can provide for assembling plural kinds of related electronic devices, such as the aforementioned power supply, hard disk drive or motherboard. In order to keep tidy for the interior space to assure better air circulation ability, the wire keeper 20 called by the present invention can be assembled on a plane 4011 of the case 401 at a position between a rear side power supply 41 and a front side hard disk drive 42. This position is usually a place where heat is concentrated more. By the implementation of the present invention, related wires 43 can be orderly aligned and fixed into each through-hole 202, 203 of the wire keeper 20. As shown in the drawing, each wire 43 is aligned along a same direction and is limited to each through-hole 202, 203. Thus, the space at this location will not be disordered again, and the air circulation ability at this space can be assured. In addition, as shown in the drawing again, another wire keeper 10, which is formed with fewer through-holes 102,103, can be provided on a narrower plane 4012, such that neighboring wires 44 can be transfixed and fixed properly.

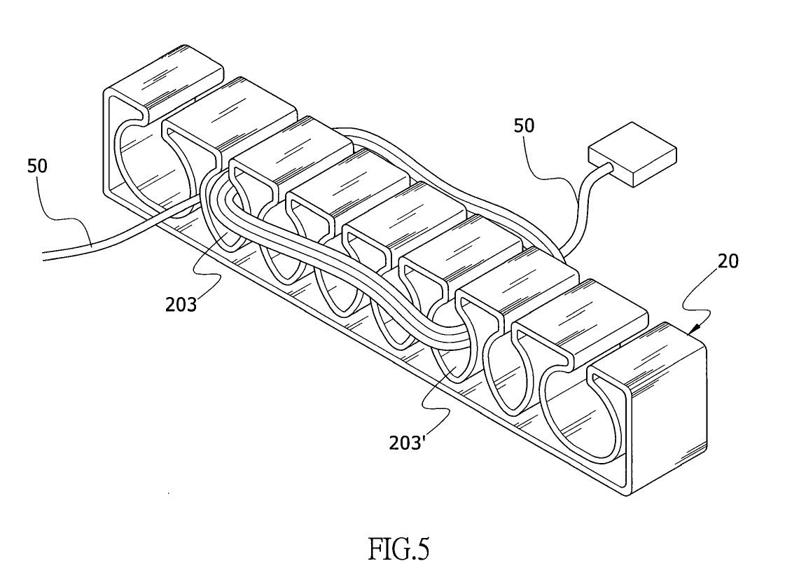

Referring to FIG. 5, it shows a schematic view of a fourth preferred embodiment of the present invention. As shown in the drawing, after being transfixed into one through-hole 203 of the wire keeper 20, a wire 50 is transfixed into another through-hole 203′ and is wound circumferentially to be fixed. This application method can allow the wire 50, which is not necessary to be connected temporarily in the interior of the case, to be fixed by winding, using the existing through-holes 203 and 203′ of the wire keeper 20. The two through-holes 203 and 203′, whereas, can be next to each other or can be separated by a few through-holes.

Accordingly, the wire keeper called by the present invention can be attached on a proper plane in a case according to a requirement upon assembling a computer. The through-holes formed, whereas, can provide for transfixing plural wires of electric connecting cords, and allow each wire to be guided toward a same axial direction, thereby achieving an effect of tidiness. Moreover, the wires which are transfixed are integrated and fixed effectively. In addition, the wire keeper called by the present invention can be manufactured with the through-holes of different sizes and quantities according to all kinds of specifications, allowing the entire wire keeper to better comply with the need of use. Concluding above, after implementing the present invention, an object of providing a wire keeper which can be assembled in the computer case and is provided with the functions of guiding, integrating and fixing the wires is actually achieved.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A wire keeper which is assembled on a plane of a computer case to align and fix wires of an electric connecting cord after the wires have been transfixed, comprising an assembly portion which is extended upward to form more than one through-hole, with an upper rim of each through-hole being formed with an insertion slot.

2. The wire keeper according to claim 1, wherein the assembly portion, the through-hole and the insertion slot are formed integrally.

3. The wire keeper according to claim 1, wherein the through-hole is elastic.

4. The wire keeper according to claim 1, wherein the insertion slot is elastic.

5. The wire keeper according to claim 1, wherein plural through-holes are formed and each through-hole is provided with a same aperture size.

6. The wire keeper according to claim 1, wherein plural through-holes are formed and each through-hole is provided with a different aperture size.

7. The wire keeper according to claim 1, wherein a bottom plane of the assembly portion is provided with a double sided adhesive.
